(19) United States
(12) Patent Application Publication
(10) Pub. No.: US 2025/0225354 A1
(43) Pub. Date: Jul. 10, 2025

(54) ELECTRONIC APPARATUS, INFORMATION PROCESSING APPARATUS, CONTROL METHOD OF ELECTRONIC APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventors: RINA ICHIGE, Kanagawa (JP); KAZUHISA FUJINO, Kanagawa (JP)

(21) Appl. No.: 19/007,875

(22) Filed: Jan. 2, 2025

(30) Foreign Application Priority Data
Jan. 4, 2024 (JP) 2024-000137

(51) Int. Cl. G06K 15/00

(52) U.S. Cl. CPC G06K 15/002; G06K 15/406

(57) ABSTRACT

An electronic apparatus that communicates with an information processing apparatus that includes at least one memory storing a program and at least one processor, that when executes the program, causes the electronic apparatus to receive a job from the information processing apparatus, enable or disable a specific function causing the electronic apparatus to transition to a first state from a second state in response to receiving the job in the second state, the second state having lower power consumption than the first state, and perform, in a case where a power-on operation is performed on the electronic apparatus in a state where the specific function is disabled, control to display a screen prompting enabling of the specific function based on receiving a job satisfying a predetermined condition, and executing an operation based on the received job.

### BACKGROUND

### Field

The present disclosure relates to an electronic apparatus, an information processing apparatus, a control method of an electronic apparatus, a control method of an information processing apparatus, and a storage medium.

### Description of the Related Art

There are information processing apparatuses equipped with an automatic power-on function that enable the information processing apparatus to shift to a power-on state in response to detecting execution of a job without having a user manually power on the information processing apparatus. During standby, an information processing apparatus with the automatic power-on function enabled transitions to a sleep state in which the information processing apparatus consumes a larger amount of power than in a power-off state and can accept jobs. Such an information processing apparatus automatically transitions to the power-on state from the sleep state in response to receiving a job for printing, scanning, or the like using a Universal Serial Bus (USB) interface or a network. The automatic power-on function is often disabled by default for power saving.

Japanese Patent Laid-Open No. 2018-173880 (Document 1) discloses a method in which an information processing apparatus communicates with a communication apparatus to obtain information on the communication apparatus's automatic power-on setting and requests the communication apparatus to enable the automatic power-on function in a case where the function is disabled.

In the method of Document 1, the automatic power-on function of the communication apparatus is automatically enabled in a case where the function is disabled. This means that the function will be enabled without the user realizing it, which can lead to unintended consequences for the user. Hence, the method of Document 1 does not provide for the user to realize the presence of the function in an appropriate situation and enable the function based on the user's decision.

### SUMMARY

An electronic apparatus according to an aspect of the present disclosure communicates with an information processing apparatus, the electronic apparatus including at least one memory storing a program and at least one processor that, when executing the program, causes the electronic apparatus to receive a job from the information processing apparatus, to enable or disable a specific function causing the electronic apparatus to transition to a first state from a second state in response to receiving the job in the second state, the second state having lower power consumption than the first state, to perform, in a case where a power-on operation is performed on the electronic apparatus in a state where the setting unit has disabled the specific function, control to display a screen prompting enabling of the specific function based on receiving a job satisfying a predetermined condition, and executing an operation based on the received job.

Further features of the present disclosure will become apparent from the following description of exemplary embodiments with reference to the attached drawings.

### BRIEF DESCRIPTION OF THE DRAWINGS

FIG. 1A is an exterior view illustrating an example of a configuration of an electronic apparatus;

FIG. 1B is an exterior view of the upper face of the electronic apparatus;

FIG. 2 is a block diagram illustrating an example of a configuration of the electronic apparatus;

FIG. 3 is a block diagram illustrating an example of a configuration of an information processing apparatus;

FIG. 4A is a diagram illustrating an example of a configuration of a print job information;

FIG. 4B is a diagram illustrating an example of a print job header section;

FIG. 4C is a diagram illustrating an example of a print job data section;

FIG. 5A is a diagram illustrating an example of contents of print job log information;

FIG. 5B is a diagram illustrating an example of contents of main body setting information;

FIG. 6 is a diagram illustrating an example of communication information of the information processing apparatus;

FIG. 7A is a diagram illustrating an example of an automatic power-on setting screen;

FIG. 7B is a diagram illustrating an example of a print preview screen;

FIG. 7C is a diagram illustrating an example of a printing-in-progress notification;

FIG. 7D is a diagram illustrating an example of a communication error notification;

FIG. 7E is a diagram illustrating an example of a recommendation notification screen;

FIG. 8 is a flowchart illustrating an example of an automatic power-on setting process;

FIG. 9A is a flowchart illustrating an example of a power-off process in the electronic apparatus;

FIG. 9B is a flowchart illustrating an example of a process of displaying a recommendation notification screen;

FIG. 10A is a flowchart illustrating an example of a power-off process in an electronic apparatus;

FIG. 10B is a flowchart illustrating an example of a process in the electronic apparatus; and

FIG. 11 is a flowchart illustrating an example of a process in an information processing apparatus.

### DESCRIPTION OF THE EMBODIMENTS

Exemplary embodiments of the present disclosure will be described below with reference to the accompanying drawings. The following embodiments do not limit the contents of the present disclosure, and not all of the combinations of the features described in the following embodiments are necessarily essential for the solution to be provided by the present disclosure. The description will be given with the same reference signs given to identical components.

### First Embodiment

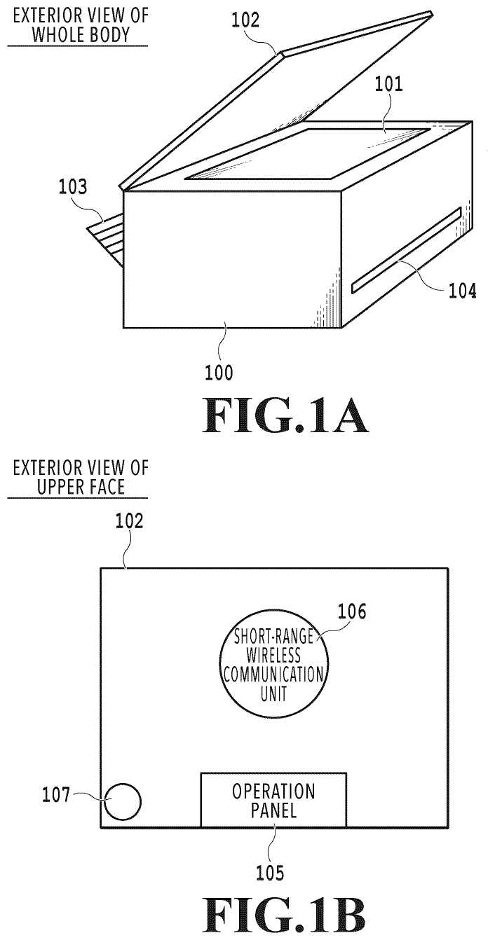

FIG. 1 is an exterior view illustrating an example of a configuration of a printer 100 in a first embodiment. In the present embodiment, the printer 100 will be described as an example of an electronic apparatus. Also, in the present embodiment, the printer 100 will be described as a multi-function printer (MFP), which is a printer equipped with a scanner function and/or other functions.

FIG. 1A illustrates an exterior view of the printer 100. A document positioning plate 101 is a glassy clear plate and is used to read a document placed thereon with a scanner. A document positioning plate pressing plate 102 is a cover to be pressed against the document positioning plate to keep a document thereon from floating in a case of reading it with the scanner and also to block entry of external light into a scanner unit. A print sheet insertion opening 103 is a sheet insertion opening from which to supply sheets of various sizes. Sheets set in this opening are conveyed one by one to a printing unit, subjected to desired printing, and discharged from a print sheet ejection opening 104 as a printed product.

FIG. 1B illustrates an exterior view of the upper face of the printer 100. An operation panel 105 and a short-range wireless communication unit 106 are disposed in the top of the document positioning plate pressing plate 102. The operation panel 105 includes a touch panel-type liquid crystal display not illustrated and presents various displays. Also, multiple keys not illustrated for accepting operations from the user are provided on the outer surface of the operation panel 105. The operation panel 105 functions as a display unit that accepts various operations for the printer 100, password input operations, and the like from the user. The short-range wireless communication unit 106 is a unit for performing short-range wireless communication and communicates with short-range wireless communication units of communication targets present within a predetermined distance. A wireless local area network (LAN) unit 107 is embedded as an antenna for connecting to a LAN and performing communication using a wireless LAN router.

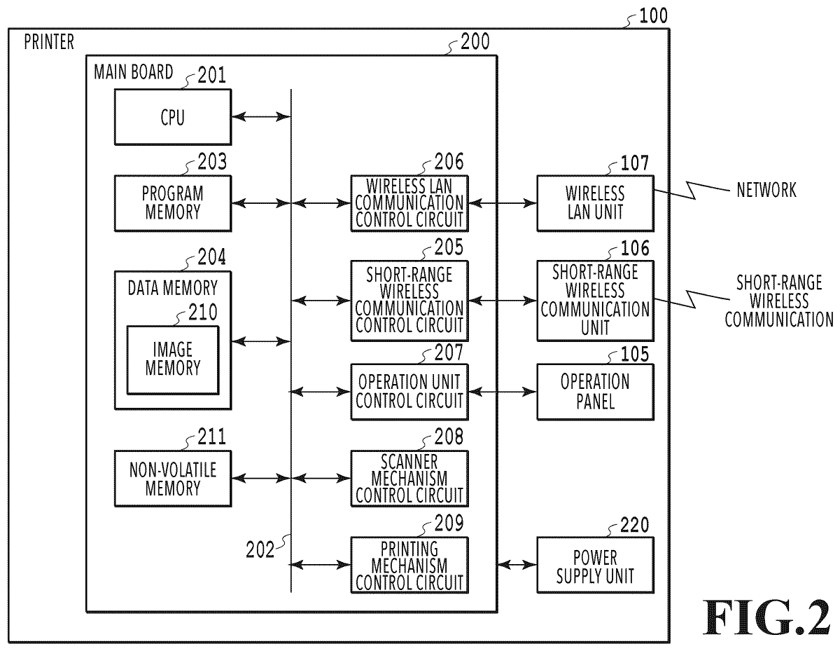

FIG. 2 is a block diagram illustrating an example of a configuration of the printer 100 in the present embodiment. The printer 100 has a main board 200 that comprehensively controls the apparatus, the wireless LAN unit 107, the short-range wireless communication unit 106, the operation panel 105, and a power supply unit 220. The main board 200 includes a central processing unit (CPU) 201, a program memory 203, and a data memory 204. The main board 200 includes a short-range wireless communication control circuit 205, a wireless LAN communication control circuit 206, an operation unit control circuit 207, a scanner mechanism control circuit 208, a printing mechanism control circuit 209, and a non-volatile memory 211.

The printer 100 communicates with a host terminal 300 to be described later by using the wireless LAN unit 107, and receives various jobs, such as print jobs, from the host terminal 300. The CPU 201 in the form of a microprocessor disposed on the main board 200 reads out a control program stored in the program memory 203 in the form of a rear-only memory (ROM) connected through an internal bus 202 into the data memory 204 in the form of a random-access memory (RAM), and executes various types of control.

The CPU 201 reads a document by controlling the scanner mechanism control circuit 208, and stores the result in an image memory 210 in the data memory 204. The CPU 201 can also perform print control to print an image in the image memory 210 in the data memory 204 on a print medium by controlling the printing mechanism control circuit 209. The CPU 201 performs wireless LAN communication with other communication terminal apparatuses by controlling the wireless LAN unit 107 via the wireless LAN communication control circuit 206. The CPU 201 can also, for example, detect connections with other short-range wireless communication terminals and sending and receiving data to and from the other short-range wireless communication terminals by controlling the short-range wireless communication unit 106 via the short-range wireless communication control circuit 205. The CPU 201 can perform display control to display a status of the printer 100, a function selection menu, etc., on the operation panel 105 by controlling the operation unit control circuit 207, and accepting operations from the user.

The CPU 201 can also accept an operation on a power button of the printer 100 via the operation unit control circuit 207. An operation of selecting the power button to switch the printer 100 from a power-off state to a power-on state will be hereinafter referred to as “power-on operation.” An operation of selecting the power button to switch the printer 100 from the power-on state to the power-off state will be hereinafter referred to as “power-off operation.” The non-volatile memory 211 is a flash memory or the like, and stores data desired to be saved even after the printer 100 is put into the power-off state. For example, the non-volatile memory 211 stores print job data, information on various communication connections, information on previously connected devices, and so on.

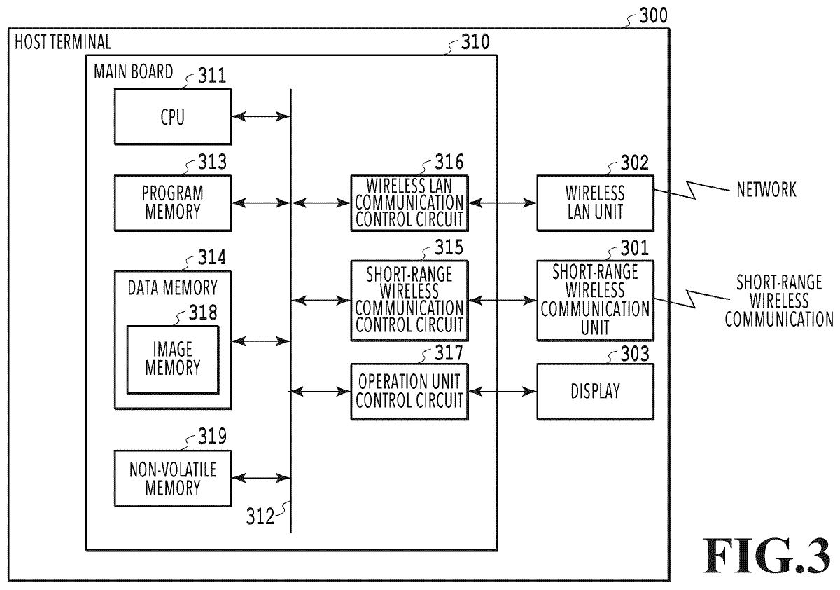

FIG. 3 is a block diagram illustrating an example of a configuration of an information processing apparatus. In the present embodiment, the host terminal 300 will be described as an example of the information processing apparatus. The host terminal 300 includes a main board 310 that comprehensively controls the apparatus, a wireless LAN unit 302, a short-range wireless communication unit 301, and a display 303. The main board 310 includes a CPU 311, a program memory 313, a data memory 314, a short-range wireless communication control circuit 315, a wireless LAN communication control circuit 316, an operation unit control circuit 317, and a non-volatile memory 319.

The CPU 311 in the form of a microprocessor disposed on the main board 310 reads out a control program stored in the program memory 313 in the form of a ROM connected through an internal bus 312 into the data memory 314 in the form of a RAM, and executes various types of control. The CPU 311 performs wireless LAN communication with other communication terminal apparatuses by controlling the wireless LAN unit 302 via the wireless LAN communication control circuit 316. For example, the host terminal 300 can wirelessly connecting to the printer 100 via the wireless LAN unit 302 and sending various jobs, such as print jobs, to the printer 100 by wireless communication. The CPU 311 can, for example, detect connections to other short-range wireless communication terminals and sending and receiving data to and from the other short-range wireless communication terminals by controlling the short-range wireless communication unit 301 via the short-range wireless communication control circuit 315.

The CPU 311 can perform display control to present desired displays on the display 303, which functions as a display unit, by controlling the operation unit control circuit 317 and accepting operations from the user. The CPU 311 stores images obtained externally through a LAN or short-range wireless communication in an image memory 318 in the data memory 314. The non-volatile memory 319 is a flash memory or the like, and stores data desired to be saved even after the host terminal 300 is put into a power-off state. For example, the non-volatile memory 319 stores information on various communication connections, information on previously connected devices, and so on as well as image data desired to be saved, application software that enables the host terminal 300 to implement various functions, and so on.

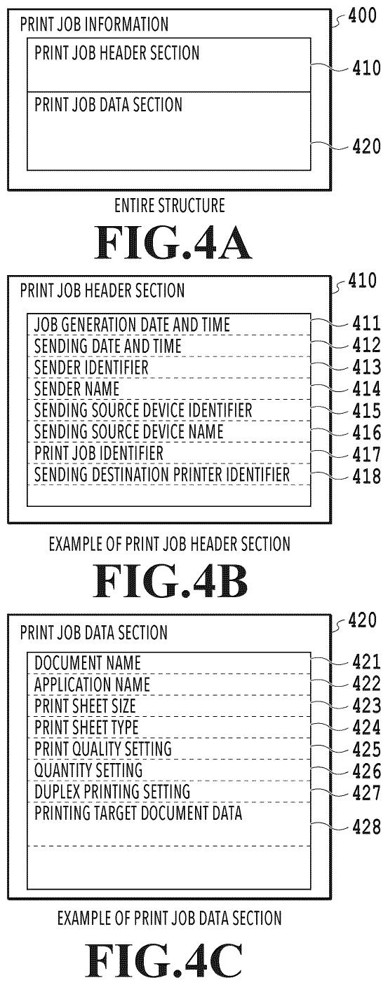

FIGS. 4A to 4C are diagrams illustrating an example structure of data of a print job to be executed by the printer 100. The printer 100 obtains print job information 400 as illustrated in FIG. 4 for a job which the printer 100 is instructed to execute by the host terminal 300.

FIG. 4A is a diagram illustrating an example of a configuration of the print job information 400. The print job information 400 includes a print job header section 410 and a print job data section 420. The print job header section 410 stores information as described later that is necessary for distinguishing the print job. The print job data section 420 stores information as described later that is necessary for executing the print job.

FIG. 4B is a diagram illustrating an example of the print job header section 410. The print job header section 410 includes a job generation date and time 411, a job sending date and time 412, a sender identifier 413, a sender name 414, a sending source device identifier 415, a sending source device name 416, a print job identifier 417, and a sending destination printer identifier 418.

The job generation date and time 411 indicates the date and time on and at which the print job was generated. As the date and time information, information indicating the year, month, date, hour, minute, and second is used, but time information in a smaller unit such as the millisecond may be included as necessary. The job sending date and time 412 indicates the date and time on and at which the print job was sent from the sending source. The sender identifier 413 is an identifier uniquely identifying the user at the sending source. The sender name 414 is any character string indicating the name of the user at the sending source. The sending source device identifier 415 is an identifier uniquely identifying the device at the sending source. The sending source device name 416 is any character string indicating the name of the device at the sending source. A print job identifier 417 is an identifier uniquely identifying the print job information 400. The sending destination printer identifier 418 is an identifier uniquely identifying the printer 100 as the sending destination for the print job information 400. In other words, the sending destination printer identifier 418 indicates the printer 100 that will execute the print job to perform printing. Note that the print job header section 410 can include information other than the pieces of information listed above.

FIG. 4C is a diagram illustrating an example of the print job data section 420. The print job data section 420 includes a document name 421 of the printing target, a name 422 of an application that will generate the print job, and a print sheet size 423. The print job data section 420 includes a print sheet type 424, a print quality setting 425, a quantity setting 426, a duplex printing setting 427, and printing target document data 428.

The document name 421 is any character string indicating the name of the printing target document of the print job. The application name 422 is any character string indicating the name of the application that created the printing target document. The print sheet size 423 is setting information on the size of the sheet or sheets to be printed. The print sheet type 424 is setting information on the type of the sheet or sheets to be printed. The print quality setting 425 is setting information on quality of the print product. The quantity setting 426 is setting information on the number of copies to be printed. The duplex printing setting 427 is setting information on duplex printing. The printing target document data 428 is data indicating the contents to be printed. Examples of the printing target document data 428 include text data and image data of each page forming the document and the like. Note that the print job data section 420 can include information other than the pieces of information listed above. Also, the job information to be obtained by the printer 100 can be information on scanning, copying, faxing, or the like other than printing.

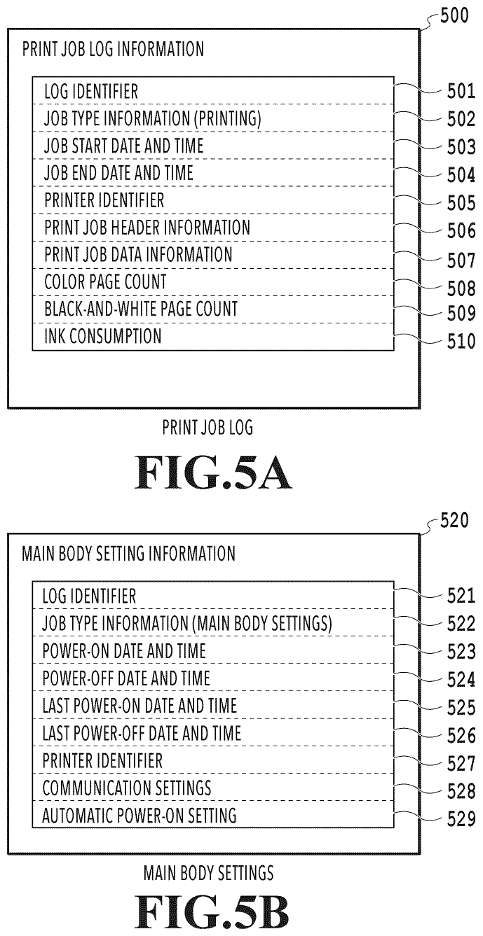

FIGS. 5A and 5B are diagrams illustrating example structures of pieces of data saved in the non-volatile memory 211 inside the main body of the printer 100.

FIG. 5A is a diagram illustrating contents of print job log information 500 saved in the printer 100. The print job log information 500 is log information which the printer 100 obtains after the printer 100 executes a print job including the print job information 400. The print job log information 500 includes log identifier 501, job type information 502, job start date and time 503, and job end date and time 504. The print job log information 500 includes a printer identifier 505, print job header information 506, print job data information 507, a color page count 508, a black-and-white page count 509, and ink consumption 510.

The log identifier 501 is an identifier uniquely identifying the job log information. The job type information 502 is information indicating the job type of the print job log information 500. The job start date and time 503 is information indicating the start date and time of the print job. The job end date and time 504 is information indicating the end date and time of the print job. The printer identifier 505 is an identifier uniquely identifying the printer 100. The print job header information 506 is information indicating the contents of the print job header section 410 of the print job information 400. The print job data information 507 is information indicating the contents of the print job data section 420 of the print job information 400. The color page count 508 is information on the number of color pages printed by the printer 100 by executing the print job. The black-and-white page count 509 is information on the number of black-and-white pages printed by the printer 100 by executing the print job. The ink consumption 510 is information on the amount of the ink of each color used by the printer 100 in the printing by executing the print job. Note that the print job log information 500 can include information other than the pieces of information listed above.

FIG. 5B is a diagram illustrating contents of main body setting information 520 saved in the printer 100. The main body setting information 520 includes a log identifier 521, job type information 522, a power-on date and time 523, a power-off date and time 524, a last power-on date and time 525, a last power-off date and time 526, a printer identifier 527, communication settings 528, and an automatic power-on setting 529. Note that the log identifier 521, the job type information 522, and the printer identifier 527 are as described above, and description thereof is thereof omitted.

The power-on date and time 523 indicates the date and time on and at which the printer 100 was brought to the power-on state. The power-off date and time 524 indicates the date and time on and at which the printer 100 shifted to the power-off state. The last power-on date and time 525 indicates the date and time on and at which the printer 100 was brought to the power-on state last time. The last power-off date and time 526 indicates the date and time on and at which the printer 100 was brought to the power-off state last time. Specifically, in a case where the printer 100 is brought to the power-on state, a first date and time on and at which the printer 100 is brought to the power-on state is stored as the power-on date and time 523. In a case where the printer 100 is then brought to the power-off state, a second date and time on and at which the printer 100 is brought to the power-off state is stored as the power-off date and time 524. In a case where the printer 100 is then brought to the power-on state again, a third date and time on and at which the printer 100 is brought to the power-on state is stored as the power-on date and time 523. At the same time, the first date and time is stored as the last power-on date and time 525. In a case where the printer 100 is then brought to the power-off state again, a fourth date and time at which the printer 100 is brought to the power-off state is stored as the power-off date and time 524. At the same time, the second date and time is stored as the last power-off date and time 526.

The communication settings 528 are setting information necessary for the printer 100 to perform communication. The automatic power-on setting 529 is setting information for enabling or disabling an automatic power-on function. Details of the automatic power-on setting 529 will be described later. Note that the main body setting information 520 can include information other than the pieces of information listed above.

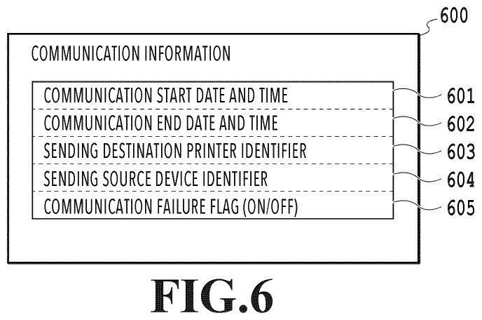

FIG. 6 is a diagram illustrating an example of communication information generated by the host terminal 300. The communication information 600 is communication information generated in a case where the host terminal 300 communicates with the printer 100 via the short-range wireless communication unit 301 or the wireless LAN unit 302. The communication information 600 includes a communication start date and time 601, a communication end date and time 602, a sending destination printer identifier 603, a sending source device identifier 604, and a communication failure flag 605.

The communication start date and time 601 indicates the date and time on and at which the communication with the printer 100 started. The communication end date and time 602 indicates the date and time on and at which the communication with the printer 100 ended. The sending destination printer identifier 603 is an identifier uniquely identifying the printer at the sending destination. The sending source device identifier 604 is an identifier uniquely identifying the device at the sending source. The communication failure flag 605 is a flag indicating whether the communication with the printer 100 failed. The communication failure flag 605 is off at the time of generating the communication information 600 and is written to be on in a case where the communication with the printer 100 fails. Note that the communication information 600 can include information other than the pieces of information listed above.

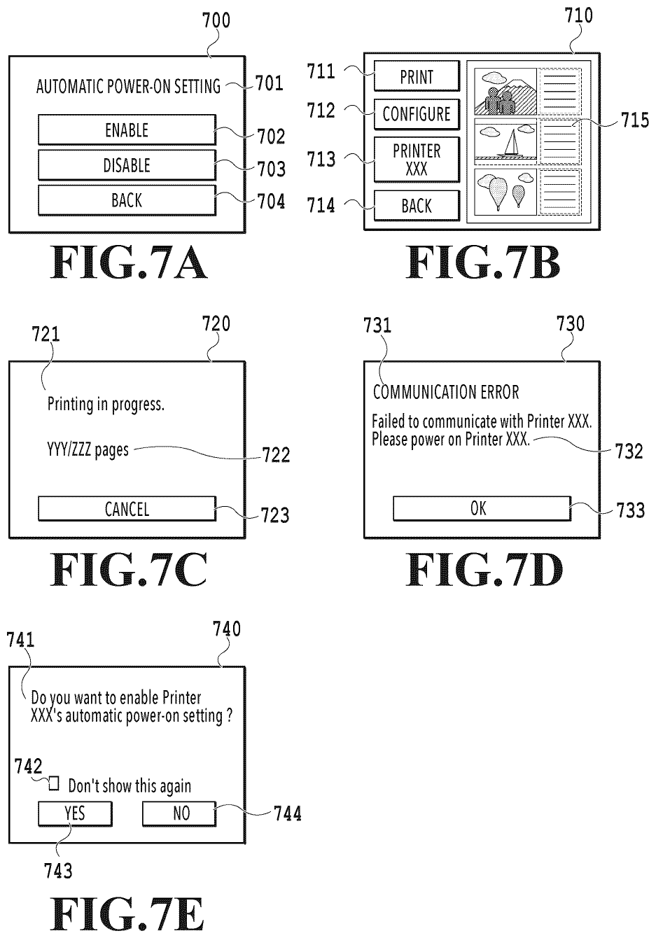

FIGS. 7A to 7E are diagrams illustrating an example of display screens to be displayed on the operation panel 105 of the printer 100 or the display 303 of the host terminal 300 or both of them in the present embodiment.

FIG. 7A illustrates an automatic power-on setting screen 700 to be displayed on the operation panel 105 of the printer 100. The automatic power-on setting screen 700 accepts a choice to enable or disable the automatic power-on function of the printer 100 through the user's operation. The automatic power-on setting screen 700 includes a screen name display region 701, an enable button 702, a disable button 703, and a back button 704. Hereinafter, a display item that is displayed in a screen and accepts execution of a predetermined process by the CPU through the user's operation on the display item will be referred to as “button.” The user selects the enable button 702 in a case of enabling the automatic power-on function, and selects the disable button 703 in a case of disabling the automatic power-on function. Here, the user can perform the selection operation by touching a button displayed on the touch panel of the operation panel 105 or perform the selection operation on a key provided on the outer surface of the operation panel 105. The printer 100 enables or disables the automatic power-on function based on the user's operation and then stores the information on the automatic power-on function as the automatic power-on setting 529 in the main body setting information 520. Note that the automatic power-on function of the printer 100 can be set as disabled as an initial setting.

FIG. 7B illustrates a print preview screen 710 to be displayed on the operation panel 105 of the printer 100 or the display 303 of the host terminal 300. The print preview screen 710 is a screen for accepting print settings and the like through the user's operations before a print job is sent. The print preview screen 710 includes a print button 711, a configure button 712, a printer select button 713, a back button 714, and a document preview 715.

The document preview 715 is a reduced image of the first page in the printing target document. The configure button 712 accepts configuration of settings of the print job. The printer select button 713 accepts selection of a printer that will execute the job. Selecting the print button 711 will generate the print job information 400 based on parameters set via the configure button 712 and sends the print job including the print job information 400 to the printer designated via the printer select button 713.

FIG. 7C illustrates a printing-in-progress notification 720 to be displayed on the operation panel 105 of the printer 100. The printing-in-progress notification 720 is a screen to be displayed in a case where the printer 100 receives a print job. While the printing-in-progress notification 720 is displayed, a printed page count 722 is displayed which indicates the number of pages that have been printed among the number of pages to be printed set in the print job. Also, in a case where a print cancel button 723 is selected while the printing-in-progress notification 720 is displayed, the printer 100 will stop the currently executed printing.

FIG. 7D illustrates a communication error notification 730 to be displayed on the display 303 of the host terminal 300. The communication error notification 730 is displayed in a case where the host terminal 300 fails to communicate with the printer 100 via the short-range wireless communication unit 301 or the wireless LAN unit 302 while sending a print job. The communication error notification 730 displays a communication error message 732 indicating a failure to communicate with the printer at the sending destination for the print job. In a case where an OK button 733 in the communication error notification 730 is selected, the host terminal 300 stops displaying the communication error notification 730.

FIG. 7E illustrates a recommendation notification screen 740 to be displayed on the operation panel 105 of the printer 100 or the display 303 of the host terminal 300. The recommendation notification screen 740 displays a recommendation message 741 that prompts the user to enable the automatic power-on function. A YES button 743 accepts enabling the automatic power-on function via the user's operation. A NO button 744 accepts not enabling the automatic power-on function via the user's operation. In response to accepting an operation of selecting the YES button 743, the printer 100 enables the automatic power-on function. Here, there can be a user who does not want the recommendation notification screen 740 to be displayed every time a predetermined condition is met. Note that details of the predetermined condition will be described later. In the present embodiment, the recommendation notification screen 740 is provided with a checkbox 742 for giving an instruction to not display the recommendation notification screen 740 again. The user can check the checkbox 742 to stop the recommendation notification screen 740 from being displayed in the future even in a case where the predetermined condition is met. Also, once the automatic power-on function is enabled via the user's operation, the recommendation notification screen 740 can be kept from being displayed in the future.

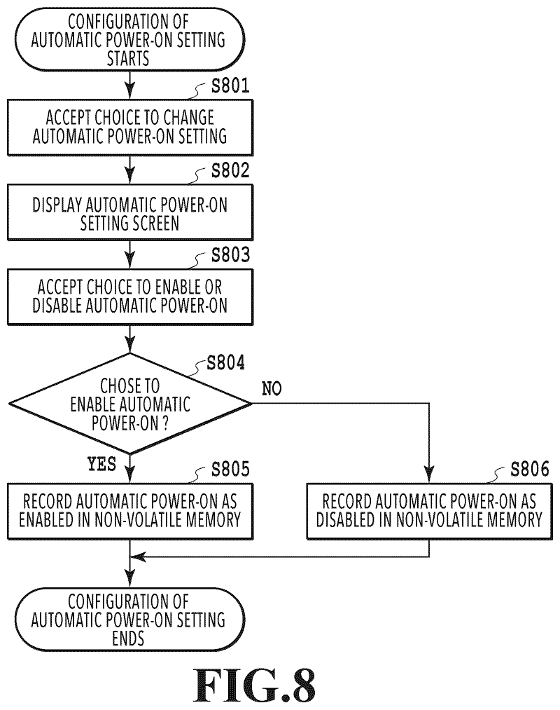

FIG. 8 is a flowchart illustrating an example of a process to be executed by the CPU 201 of the printer 100 in a case where the user configures an automatic power-on setting on the operation panel 105 of the printer 100. The CPU 201 of the printer 100 implements the process illustrated FIG. 8 by loading a control program stored in the program memory 203 in the form of a ROM to the data memory 204 in the form of a RAM and executing it. Incidentally, the functions of some or all of the steps in FIG. 8 can be implemented with hardware such as an application-specific integrated circuit (ASIC) or an electronic circuit. The symbol “S” in the description of each process means a step in the flowchart (the same applies to the other flowcharts herein). The processing illustrated FIG. 8 starts when a setting menu screen (not illustrated) of the printer 100 is displayed on the touch panel of the operation panel 105.

In S801, the CPU 201 accepts selection of a setting item for configuring the automatic power-on setting of the printer 100 by the user. Specifically, the CPU 201 accepts selection of a setting item related to the automatic power-on setting included in the setting menu screen for configuring various settings of the printer 100. Then, in response to the selection of the setting item related to the automatic power-on setting via the user's operation, the CPU 201 proceeds to the process of S802.

In S802, the CPU 201 displays a screen related to the automatic power-on setting on the touch panel of the operation panel 105. Specifically, the CPU 201 displays the automatic power-on setting screen 700 described earlier. The CPU 201 then proceeds to the process of S803.

In S803, the CPU 201 accepts a selection operation on the automatic power-on setting screen 700 by the user. Specifically, the CPU 201 accepts an operation on the enable button 702 for enabling the automatic power-on function or an operation on the disable button 703 for disabling the automatic power-on function.

In S804, the CPU 201 determines whether the user selected the enable button 702. The CPU 201 proceeds to the process of S805 if determining that the enable button 702 was selected (Yes). The CPU 201 proceeds to the process of S806 if determining that the disable button 703 was selected (No).

In S805, the CPU 201 enables the automatic power-on function. Specifically, the CPU 201 stores information indicating “enabled” as the automatic power-on setting 529 in the main body setting information 520 in the non-volatile memory 211. The CPU 201 then terminates the process illustrated in FIG. 8.

In S806, the CPU 201 disables the automatic power-on function to disabled. Specifically, the CPU 201 stores information indicating “disabled” as the automatic power-on setting 529 in the main body setting information 520 in the non-volatile memory 211. The CPU 201 then terminates the process illustrated in FIG. 8.

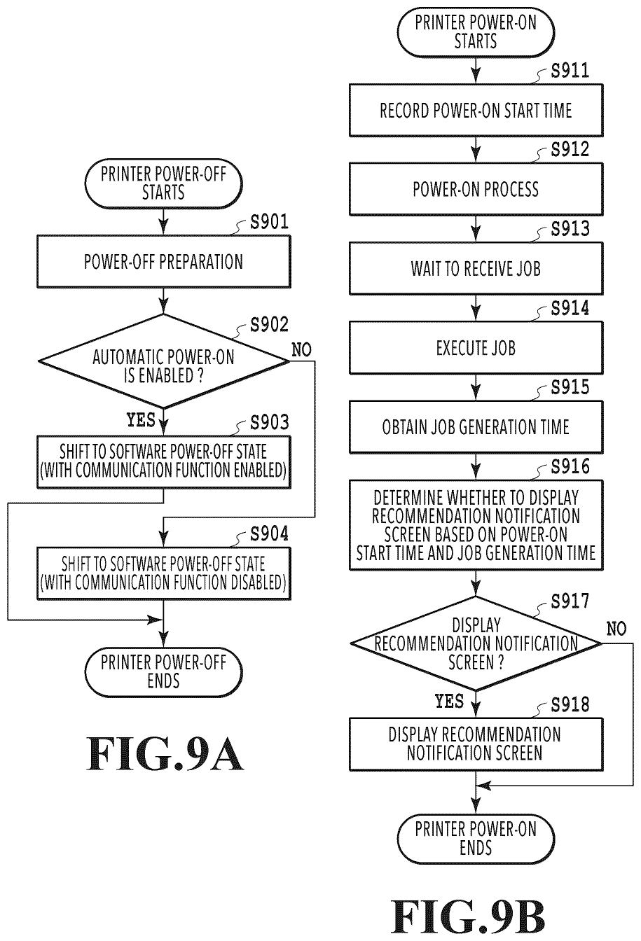

FIGS. 9A and 9B are flowcharts illustrating an example of processes to be executed by the CPU 201 of the printer 100 in the present embodiment. An example in which the printer 100 displays the recommendation notification screen 740 in a case where the difference between a job generation time and a printer power-on time is short will be described with reference to FIGS. 9A and 9B.

Consider a situation where the automatic power-on function has been disabled, the printer 100 is the power-off state, and the user powers on the printer 100 within a short period of time after sending a job from the host terminal 300. Alternatively, consider a situation where the automatic power-on function has been disabled, the printer 100 is in the power-off state, and the user sends a job from the host terminal 300 within a short period of time after powering on the printer 100. In such a situation (hereinafter “situation 1”), it is possible that the user wishes to immediately print the print job. In this case, if the automatic power-on function had been enabled, the user would not need to perform a power-on operation. Specifically, even in a case where the printer 100 is in the power-off state, sending a print job to the printer 100 from the host terminal 300 will automatically power on the printer 100, and the printer 100 will execute the received job. In sum, as compared to leaving the automatic power-on function disabled, leaving the automatic power-on function enabled allows a job to be executed quickly since doing so will eliminate the power-on operation or eliminate the waiting time before the power-on operation is completed. Thus, in the present embodiment, a notification that prompts enabling of the automatic power-on function is issued in the situation 1 mentioned above.

FIG. 9A is a flowchart illustrating an example of a power-off process in the printer 100. The process illustrated in FIG. 9A starts in response to the occurrence of an event in which the user presses the power button, an event in which an automatic power-off condition is met due to continued absence of an operation for a predetermined period of time and thus the power should be turned off, or the like.

In S901, the CPU 201 performs a power-off preparation. Specifically, in the present embodiment, the power-off preparation refers to the following process. Following a control program, the CPU 201 stops the short-range wireless communication control circuit 205 and the wireless LAN communication control circuit 206 to thereby disconnect communication between the short-range wireless communication unit 106 and the wireless LAN unit 107 and other communication terminal apparatuses. The CPU 201 also stops the operation unit control circuit 207 to thereby end the display on the touch panel of the operation panel 105 and the acceptance of operations from the user. The CPU 201 also stops the scanner mechanism control circuit 208 and the printing mechanism control circuit 209 to thereby stop reading a document and printing an image on a print medium.

In S902, the CPU 201 refers to the automatic power-on setting 529 in the main body setting information 520 in the non-volatile memory 211 and determines whether the automatic power-on function is enabled. The CPU 201 proceeds to the process of S903 if determining that the automatic power-on function is enabled (Yes). The CPU 201 proceeds to the process of S904 if determining that the automatic power-on function is disabled (No).

In S903, the CPU 201 performs control to shift to a software power-off state with the communication function enabled. As a result, the printer 100 shifts to a state with less power consumption (second state) than the power-on state (first state). The printer 100 in the second state consumes power for communication since the communication function is enabled. On the other hand, the display of the operation panel 105 is turned off, so that the CPU 201 is in a state with a lower clock speed.

In S904, the CPU 201 shifts to a software power-off state with the communication function disabled. As a result, the printer 100 shifts to a state with further less power consumption (third state) than the second state. The printer 100 in the third state does not consume power for communication since the communication function is disabled thereby allowing no communication with other apparatuses. Moreover, the display of the operation panel 105 is turned off, so that the CPU 201 is in an off state.

FIG. 9B is a flowchart illustrating an example of a process to be executed by the CPU 201 of the printer 100 in the present embodiment. A process of displaying a screen that prompts enabling of the automatic power-on function will be described with reference to FIG. 9B. The process of FIG. 9B starts in a case where the power button of the printer 100 is pressed to power it on.

In S911, the CPU 201 stores the power-on date and time 523 in the main body setting information 520 in the non-volatile memory 211. The CPU 201 then proceeds to the process of S912. In S912, the CPU 201 performs a power-on process. This brings the printer 100 to the first state mentioned earlier. Also, the display of the operation panel 105 is turned on, so that the CPU 201 is in a state with the normal clock speed. The CPU 201 then proceeds to the process of S913.

In S913, the CPU 201 waits to receive a job. If receiving a job in the above state, the CPU 201 proceeds to the process of S914. In S914, the CPU 201 executes the job received in S913. At this time, if a print job was received, the CPU 201 controls the printing mechanism control circuit 209 to execute printing based on the received print job. The CPU 201 then proceeds to the process of S915.

In S915, the CPU 201 obtains the job generation date and time 411 of the received job from the print job information 400. The CPU 201 then proceeds to the process of S916. Note that the order of the processes of S914 and S915 is not limited to the above. That is, the process of S915 can be executed before the process of S914.

In S916, the CPU 201 determines whether or not the difference (time interval) between the power-on date and time 523 stored in S911 and the job generation date and time 411 obtained in S915 is less than or equal to a first predetermined period of time (e.g., about 5 minutes). Then, based on this determination, the CPU 201 determines whether to display a screen that prompts enabling of the automatic power-on function. Specifically, if determining that the difference between the power-on date and time 523 and the job generation date and time 411 is less than or equal to the first predetermined period of time, the CPU 201 determines to display the recommendation notification screen 740. On the other hand, if determining that the difference between the power-on date and time 523 and the job generation date and time 411 is more than the first predetermined period of time, the CPU 201 determines not to display the recommendation notification screen 740. The CPU 201 then proceeds to the process of S917.

Note that an example has been described in which the recommendation notification screen 740 is displayed in the case where the CPU 201 determines that the difference between the power-on date and time 523 and the job generation date and time 411 is less than or equal to the first predetermined period of time regardless of the order of these dates and times, but the present disclosure is not limited to this case. The CPU 201 can determine to display the recommendation notification screen 740 in a case where the job generation date and time 411 precedes the power-on date and time 523 and the CPU 201 determines that the difference between the job generation date and time 411 and the power-on date and time 523 is less than or equal to the first predetermined period of time. In other words, the CPU 201 can determine not to display the recommendation notification screen 740 in a case of determining that the difference between the power-on date and time 523 and the job generation date and time 411 is more than the first predetermined period of time or that the job generation date and time 411 follows the power-on date and time 523. The case where the job generation date and time 411 follows the power-on date and time 523 can be, for example, a case where the user performs a power-on operation on the printer and then sends a job from the host terminal, as normally done. In such a case, the printer does not need to display the recommendation notification screen.

In S917, the CPU 201 determines whether to display the recommendation notification screen 740 based on the result of the determination in S916. Specifically, the CPU 201 proceeds to the process of S918 if determining to display the recommendation notification screen 740 (Yes) in S916. The CPU 201 terminates the process illustrated in FIG. 9B without displaying the recommendation notification screen 740 if determining not to display the recommendation notification screen 740 (No) in S916.

In S918, the CPU 201 displays the recommendation notification screen 740 on the display of the operation panel 105 and terminates the process illustrated in FIG. 9B. What is displayed in this case is as described with reference to FIG. 7E, for example.

As described above, in the present embodiment, the printer 100 presents a display that prompts enabling of the automatic power-on function in a case where the difference between the date and time on and at which a job was generated and the time at which a power-on operation was performed on the printer 100 is short. A possible case where the difference between the date and time on and at which a job was generated and the time at which a power-on operation was performed is short can be a case where the user has sent a job to the printer 100 from the host terminal 300 but realizes that the printer 100 has been powered off and immediately powers on the printer 100. In this case, if the automatic power-on function has been enabled, there will not be a situation where a job has been sent to the printer 100 from the host terminal 300 but the printing is not performed, and the printer 100 will get automatically powered on by the automatic power-on function and quickly perform the printing.

Thus, as compared a case where the automatic power-on function has been disabled, the user can save time and effort in powering on the printer 100. Specifically, the above case is a case where the automatic power-on function being enabled is assumed to be advantageous to the user. In this case, if the automatic power-on function has been disabled, there is a possibility that the user may not have realized at least one of the presence of the automatic power-on function, that the automatic power-on function has been disabled, or that enabling the automatic power-on function is advantageous to the user. In such a case, in the present embodiment, the recommendation notification screen 740 is displayed to prompt the user to enable the automatic power-on function. This lowers the possibility of the user continuing to use the printer 100 without realizing any of the presence of the automatic power-on function, that the automatic power-on function has been disabled, and the advantage of the automatic power-on function. In sum, in accordance with the present embodiment, the user can utilize the automatic power-on function in a more appropriate manner.

### Second Embodiment

One possible example of a use case of a printer with an automatic power-on function is a case where the user powers off the printer once but starts wanting to perform printing shortly thereafter that and powers on the printer. In such a case, enabling the automatic power-on function is advantageous to the user, and the printer therefore displays a recommendation notification screen.

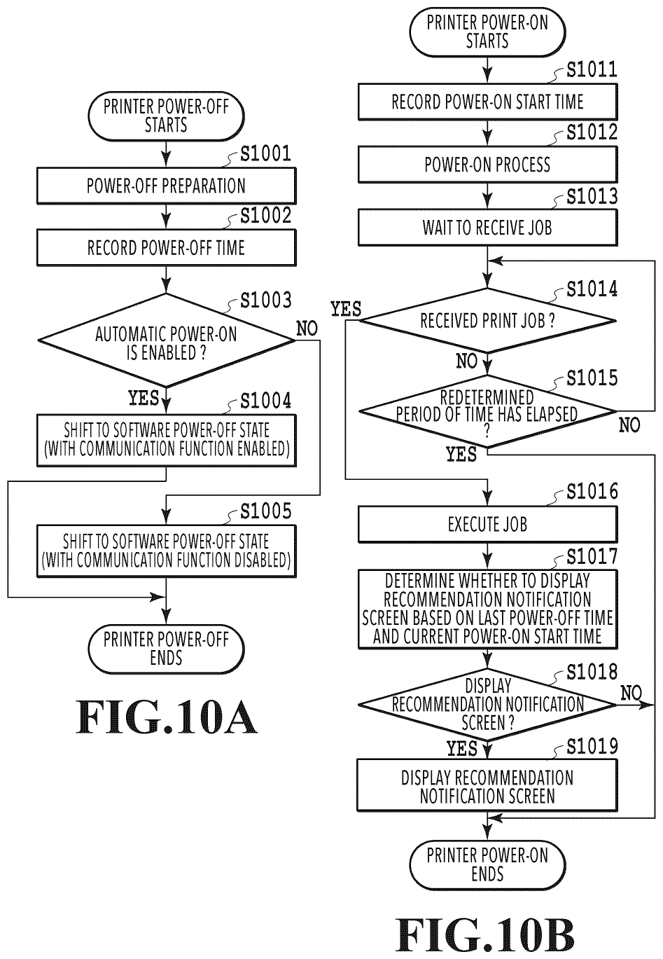

FIGS. 10A and 10B are diagrams each illustrating an example of a process to be executed by the CPU 201 of the printer 100 in a second embodiment. An example in which the printer 100 displays the recommendation notification screen 740 in a case where the time interval between the printer 100 being in the power-on state and the printer 100 being in the power-off state is less than a threshold value will be described with reference to FIGS. 10A and 10B.

The configuration of the printer 100, the display screens, the procedure to configure the automatic power-on setting, and so on are common to those in FIGS. 1A to 8 in the first embodiment, and description thereof is therefore omitted. FIG. 10A is a flowchart illustrating an example of a power-off process in the printer 100. The process of FIG. 10A starts in response to the occurrence of an event in which the user presses the power button of the printer 100, an event in which an automatic power-off condition is met due to continued absence of an operation for a predetermined period of time and thus the power should be turned off, or the like. Note that S1001 and S1003 to S1005 are similar processes to S901 to S904 in FIG. 9A and description thereof is therefore omitted.

After completion of power-off preparation in S1001 is S1002, in which the CPU 201 stores the power-off date and time 524 (the time at which the power-off operation was performed) in the main body setting information 520 in the non-volatile memory 211.

FIG. 10B is a flowchart illustrating an example of a process to be executed by the CPU 201 of the printer 100 in the present embodiment. The process of FIG. 10B starts in a case where the power button of the printer 100 is pressed to power it on.

In S1011, the CPU 201 stores the power-on date and time 523 (the time at which the power-on operation was performed) in the main body setting information 520 in the non-volatile memory 211, and stores the value stored as the power-off date and time 524 in the last power-off date and time 526. The CPU 201 then proceeds to the process of S1012. Since S1012 and S1013 are similar to S912 and S913, respectively, description thereof is omitted.

In S1014, the CPU 201 determines whether a print job was received from the host terminal 300 in S1013. The CPU 201 proceeds to the process of S1016 if determining that a print job was received from the host terminal 300 (Yes). The CPU 201 proceeds to the process of S1015 if determining that no print job was received from the host terminal 300 (No).

In S1015, the CPU 201 determines whether a first period of time (e.g., about 10 minutes) has elapsed since the printer 100 was brought to the power-on state. Specifically, the CPU 201 determines whether a preset period of time has elapsed since the date and time stored as the power-on date and time 523. Time can be measured, for example, by setting a timer when the power-on date and time 523 is stored in S1011. Note that use of a timer is not limited to this case. A timer can be used also in any of the processes to be described below where time needs to be measured. The CPU 201 terminates the process illustrated in FIG. 10B if determining that the first period of time has elapsed (Yes). The CPU 201 proceeds to the process of S1014 if determining that the first period of time has not elapsed (No). Here, the case where it is determined Yes in S1014 is a case where the printer 100 receives a print job within the first period of time after shifting to the power-on state. A case where the printer 100 does not receive a print job within the first period of time after shifting to the power-on state is assumed to be a case where the user does not need the automatic power-on function. In this case, the CPU 201 does not display the recommendation notification screen 740. In S1016, the CPU 201 executes the received print job. Specifically, the CPU 201 controls the printing mechanism control circuit 209 to execute printing based on the received print job.

In S1017, the CPU 201 determines whether or not the time interval between the last power-off date and time 526 and the power-on date and time 523 is less than or equal to a second period of time (e.g., about 5 minutes). If determining that the time interval between the last power-off date and time 526 and the power-on date and time 523 is less than or equal to the second period of time (Yes), the CPU 201 determines to display the recommendation notification screen 740. On the other hand, if determining that the time interval between the last power-off date and time 526 and the power-on date and time 523 is more than the second period of time (Yes), the CPU 201 determines not to display the recommendation notification screen 740. The CPU 201 then proceeds to the process of S1018.

In S1018, the CPU 201 determines whether it determined to display the recommendation notification screen 740 in S1017. If having determined to display the recommendation notification screen 740 (Yes), the CPU 201 proceeds to the process of S1019. On the other hand, if having determined not to display the recommendation notification screen 740 (No), the CPU 201 terminates the process illustrated in FIG. 10B without displaying the screen. In S1019, the CPU 201 displays the recommendation notification screen 740 on the display of the operation panel 105. What is displayed in this case is as described with reference to FIG. 7E, for example.

Here, in the present embodiment, an example has been described in which the condition to display the recommendation notification screen is when the printer 100 determines that the time interval between the last power-off time and the power-on time is less than or equal to the second period of time, but the present disclosure is not limited to this case. For example, the condition to display the recommendation notification screen can be when a process in which the printer 100 determines that the time interval between the last power-off time and the power-on time is less than a threshold value occurs multiple times within a particular period determined in advance. In particular, the CPU 201 can perform a process as below. The CPU 201 stores a count variable for counting the number of times the time interval from the last power-off time to the power-on time is less than a threshold value in the non-volatile memory 211. The CPU 201 updates this count variable by incrementing it by 1 each time the CPU 201 determines that the time interval from the last power-off time to the power-on time is less than the threshold value. The CPU 201 initializes the count variable to 0 in a case where the count variable is not incremented for a specific period (e.g., about 30 minutes) after the last incrementation of the count variable. The CPU 201 displays the recommendation notification screen 740 in a case where the count variable reaches a predetermined value (e.g., 3).

In the present embodiment, the printer 100 presents a display that prompts enabling of the automatic power-on function in a case where the printer 100 receives a job from the host terminal 300 within the first period of time after shifting to the power-on state and the time interval between the last power-off time and the current power-on time is less than or equal to the second period of time. Here, the case where the printer 100 receives a job from the host terminal 300 within the first period of time after shifting to the power-on state is, for example, a case where the printer 100 receives a print job soon after shifting to the power-on state. Further, the case where the time interval between the last power-off time and the current power-on time is less than or equal to the second period of time is, for example, a case where the user sent a print job and powered off the printer 100 after the printing was finished but powered on the printer 100 shortly thereafter and sent a print job.

In such a case, it is possible that the user moves from in front of the display of the host terminal 300 to a position where the user can operate the printer 100 and back to in front of the display of the host terminal 300 in a short period. In this case, if the automatic power-on function has been enabled, sending a job will automatically power on the printer 100 and thus eliminate the need for the user to move from in front of the host terminal 300 to the position where the user can operate the printer 100 to power on the printer. That is, if the automatic power-on function has been enabled, it is possible to save the time and effort in moving from in front of the host terminal 300 to the position where the user can operate the printer 100 and back to in front of the host terminal 300 as compared to a case where the automatic power-on function has been disabled.

Specifically, the above case is a case where the automatic power-on function being enabled is assumed to be advantageous to the user. In this case, if the automatic power-on function has been disabled, there is a possibility that the user may not have realized at least one of the presence of the automatic power-on function, that the automatic power-on function has been disabled, or that enabling the automatic power-on function is advantageous to the user. According to the present embodiment, the recommendation notification screen 740 is displayed to prompt enabling of the automatic power-on function. This lowers the possibility of the user continuing to use the printer 100 without realizing any of the presence of the automatic power-on function, that the automatic power-on function has been disabled, and the advantage of the automatic power-on function. In sum, the user can utilize the automatic power-on function in a more appropriate manner.

### Third Embodiment

One possible example of a use case of a printer with an automatic power-on function is a case where the user sends a job to the printer from a host terminal and then realizes that the printer has not been powered on. In a case where the user sends a job from the host terminal in a situation where the printer has been powered off and the automatic power-on function has been disabled, the host terminal will fail to communicate with the printer and the printer will therefore not be able to receive the job from the host terminal. In such a case, enabling the automatic power-on function is advantageous to the user, and the host terminal therefore displays a recommendation notification screen.

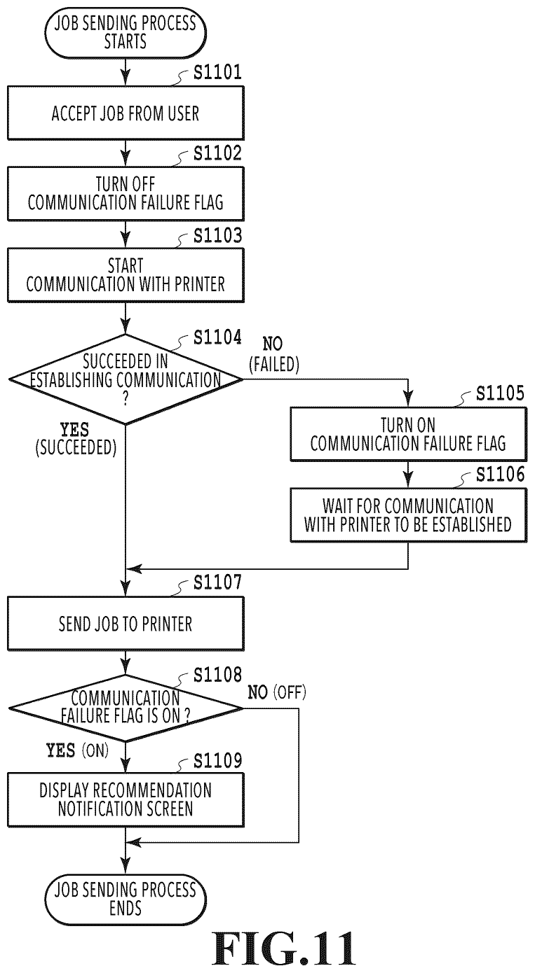

FIG. 11 is a flowchart illustrating an example of a process to be executed by the CPU 311 of the host terminal 300 in a third embodiment. An example of displaying a recommendation notification screen on the display of the host terminal 300 in a case where a job is sent to the printer 100 from the host terminal 300 while the printer 100 is in the power-off state will be described with reference to FIG. 11. The CPU 311 of the host terminal 300 implements the process illustrated FIG. 11 by loading a control program stored in the program memory 313 in the form of a ROM to the data memory 314 in the form of a RAM and executing it. The configuration of the host terminal 300, the display screens, the procedure to configure the automatic power-on setting, and so on are common to those in FIGS. 1A to 8 described earlier, and description thereof is therefore omitted. The process illustrated in FIG. 11 starts, for example, in a case where the user activates a driver for the printer 100 and then the print preview screen 710 is displayed on the display 303 of the host terminal 300.

In S1101, the CPU 311 accepts an instruction to send a job from the user. At this time, the CPU 311 executes a process for sending the later-described print job in a case where the print button 711 in the print preview screen 710 displayed on the display 303 is pressed, for example. The CPU 311 then proceeds to the process of S1102.

In S1102, the CPU 311 turns off the communication failure flag 605 in the communication information 600. The CPU 311 then proceeds to the process of S1103. In S1103, the CPU 311 starts communication with the printer 100. The CPU 311 then proceeds to the process of S1104.

In S1104, the CPU 311 determines whether it has succeeded in establishing communication with the printer 100 within a second predetermined period of time (e.g., about 1 minute). Specifically, the CPU 311 determines whether it has received a response from the printer 100 within the second predetermined period of time after starting communication for sending the job to the printer 100 in S1103. In sum, if receiving a response within the second predetermined period of time after starting communication with the printer 100, the CPU 311 determines that it has succeeded in establishing communication. The CPU 311 proceeds to the process of S1107 if determining that it has succeeded in establishing communication (Yes). The CPU 311 proceeds to the process of S1105 if determining that it has failed to establish communication (No).

In S1105, the CPU 311 turns on the communication failure flag 605 in the communication information 600. The CPU 311 then proceeds to the process of S1106. In S1106, the CPU 311 waits for communication with the printer 100 to be established by a function of the operating system (OS) of the host terminal 300. Then, if communication with the printer 100 is established, the CPU 311 proceeds to the process of S1107.

In S1107, the CPU 311 sends the job (the print job which the user instructed the CPU 311 to send in S1101) to the printer 100. The CPU 311 then proceeds to the process of S1108.

In S1108, the CPU 311 determines whether the communication failure flag 605 in the communication information 600 is on. If the CPU 311 determines that the communication failure flag 605 is on (Yes), that is, determines that it has failed to establish communication for sending the job, the CPU 311 proceeds to the process of S1109. On the other hand, if determining that the communication failure flag 605 is off (No), the CPU 311 terminates the process illustrated in FIG. 11 without displaying the recommendation notification screen 740.

In S1109, the CPU 311 displays the recommendation notification screen 740 on the display 303 of the host terminal 300, and terminates the process illustrated in FIG. 11. Then, if accepting an operation of selecting the YES button 743, the CPU 311 sends a setting change request that is information requesting to change the automatic power-on function setting from disabled to enabled to the printer 100. In response to receiving the setting change request, the printer 100 enables the automatic power-on function in accordance with the request.

As described above, in the present embodiment, the host terminal 300 presents a display that prompts enabling of the automatic power-on function in a case of failing to communicate with the printer 100 immediately (e.g., 1 minute or less) after accepting an instruction to send a job to the printer 100. The case of failing to communicate with the printer 100 immediately after accepting an instruction to send a job to the printer 100 is, for example, a case of attempting to perform communication for sending a job to the printer 100 but failing to perform the communication. Specifically, it is assumed to be a case where the printer 100 has not been powered on and the automatic power-on function has been disabled, thus stopping the printer 100 from being powered on. In this case, in order to cause the printer 100 to execute the job which the user instructed the host terminal 300 to send, the user must move to a position where the user can operate the printer 100, press its power button, and perform an operation of bringing the printer 100 to the power-on state.

In this case, if the automatic power-on function has been enabled, sending the job will automatically power on the printer 100 and thus eliminate the need for the user to move from in front of the host terminal 300 to the position where the user can operate the printer 100 to bring the printer 100 to the power-on state. That is, if the automatic power-on function has been enabled, it is possible to save the time and effort in moving between in front of the host terminal 300 and the position where the user can operate the printer 100 as compared to a case where the automatic power-on function has been disabled.

Specifically, the above case is a case where the automatic power-on function being enabled is assumed to be advantageous to the user. In this case, if the automatic power-on function has been disabled, there is a possibility that the user may not have realized at least one of the presence of the automatic power-on function, that the automatic power-on function has been disabled, or that enabling the automatic power-on function is advantageous to the user. In such a case, in the present embodiment, the recommendation notification screen 740 is displayed to prompt enabling of the automatic power-on function. This lowers the possibility of the user continuing to use the printer 100 without realizing any of the presence of the automatic power-on function, that the automatic power-on function has been disabled, and the advantage of the automatic power-on function. In sum, in accordance with the present embodiment, the user can utilize the automatic power-on function in a more appropriate manner.

Note that, in the present embodiment, an example in which the recommendation notification screen 740 is displayed on the display 303 of the host terminal 300 in S1109 after communication with the printer 100 is established and a job is sent in S1107 has been described, but the present disclosure is not limited to this example. For example, the host terminal 300 can display the recommendation notification screen 740 on the display 303 when determining that it has failed to establish communication in S1104, before performing the process of waiting for communication to be established in S1106. Here, the user is operating the host terminal 300 at the time of sending the job. In other words, it is likely that the user will not instantly realize that the cause of the failure to establish communication is the printer 100 being in the power-off state and the automatic power-on function being disabled. Nonetheless, displaying the recommendation notification screen 740 on the display 303 of the host terminal 300 at the time of failing to establish communication allows the user to instantly realize that the printer 100 is in the power-off state and thus perform an operation of powering on the printer 100.

Note that the recommendation notification screen 740 can be displayed on the display of the operation panel 105 of the printer 100 in addition to or instead of the display 303 of the host terminal 300. In this case, the CPU 311 of the host terminal 300 sends a request to display the recommendation notification screen 740 to the printer 100 in S1109.

In response to receiving this display request, the CPU 201 of the printer 100 performs control to display the recommendation notification screen 740 on the display of the operation panel 105.

### Other Embodiments

Note that each of the types of control in the above embodiments has been described to be performed by the CPU 201 of the printer 100 or the CPU 311 of the host terminal 300, but the present disclosure is not limited to this configuration. The above various types of control can be performed by a single piece of hardware, or the processes can be distributed and shared by multiple pieces of hardware (e.g., multiple processors and/or circuits) to control the apparatus.

Also, while the present disclosure has been described in detail based on its preferred embodiments, the present disclosure is not limited to these specific embodiments and encompasses various forms without departing from the gist of this disclosure. Further, each of the above embodiments is merely one embodiment of the present disclosure, and the embodiments can be combined as appropriate.

Also, the above embodiments have been described based on a case where a printer is employed as an electronic apparatus as an example, but the electronic apparatus is not limited to a printer. The present disclosure is applicable to any electronic apparatuses as long as they can receive jobs from an information processing apparatus and have an automatic power-on function, for example.

Further, the above embodiments have been described based on a case where a host terminal is employed as an information processing apparatus as an example, but the information processing apparatus is not limited to a host terminal. The present disclosure is applicable to any information processing apparatuses as long as they are can send jobs to an electronic apparatus, for example. Also, specific examples of the host terminal include a desktop personal computer (PC), a laptop PC, a tablet terminal, a mobile phone, and the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

This application claims the benefit of Japanese Patent Application No. 2024-000137, filed Jan. 4, 2024, which is hereby incorporated by reference herein in its entirety.

What is claimed is:

1. An electronic apparatus that communicates with an information processing apparatus, the electronic apparatus comprising:
at least one memory storing a program; and
at least one processor that, when executing the program, causes the electronic apparatus to:
receive a job from the information processing apparatus;
enable or disable a specific function causing the electronic apparatus to transition to a first state from a second state in response to receiving the job in the second state, the second state having lower power consumption than the first state,
perform, in a case where a power-on operation is performed on the electronic apparatus in a state where the specific function is disabled, control to display a screen prompting enabling of the specific function based on receiving a job satisfying a predetermined condition, and
executing an operation based on the received job.

2. The electronic apparatus according to claim 1, the at least one processor further configured to perform control to cause the electronic apparatus to transition from the first state to the second state in response to a power-off operation on the electronic apparatus in a case where the specific function has been enabled, and to cause the electronic apparatus to transition from the first state to a third state in response to the power-off operation in a case where the specific function has been disabled, the third state having lower power consumption than the second state.

3. The electronic apparatus according to claim 2, wherein the second state is a state in which the job can be received, and the third state is a state in which the job cannot be received.

4. The electronic apparatus according to claim 1, wherein the predetermined condition is that a difference between a time at which the power-on operation was performed and a time at which the received job was generated is less than or equal to a predetermined period of time.

5. The electronic apparatus according to claim 1, wherein the predetermined condition is that the job is received within a first period of time after the power-on operation.

6. The electronic apparatus according to claim 5, wherein the at least one processor is further configured to perform control to display the screen in a case where the received job satisfies the predetermined condition and a time interval between a time at which a last power-off operation was performed on the electronic apparatus and a time at which the power-on operation was performed is less than or equal to a second period of time.

7. The electronic apparatus according to claim 6, wherein the at least one processor is further configured to count up in a case where the time interval between the time at which the last power-off operation was performed and the time at which the power-on operation was performed is less than or equal to the second period of time, wherein
the at least one processor is further configured to perform control to display the screen in a case where the received job satisfies the predetermined condition and the number of times the counting unit has counted up reaches a predetermined value within a specific period.

8. The electronic apparatus according to claim 1, wherein the screen includes a first display item that accepts an instruction to enable the specific function, and the specific function is enabled in response to the screen accepting an operation on the first display item.

9. The electronic apparatus according to claim 8, wherein the screen includes a second display item that accepts an instruction to not display the screen again.

10. The electronic apparatus according to claim 1, wherein in a case where the specific function has previously been enabled, the at least one processor is further configured to perform control to not display the screen even if the power-on operation is performed with the specific function disabled and the received job satisfies the predetermined condition.

11. The electronic apparatus according to claim 1, the at least one processor further configured to perform control to perform printing, wherein the operation based on the received job is to perform printing.

12. An information processing apparatus that communicates with an electronic apparatus having a specific function causing the electronic apparatus to transition to a first state from a second state in response to receipt of a job in the second state, the second state having a higher power consumption that the first state, the information processing apparatus comprising:
at least one memory storing a program; and
at least one processor, that when executing the program, causes the information processing apparatus to:
perform communication with the electronic apparatus, and
perform control to display a screen prompting enabling of the specific function in a case where the communication with the electronic apparatus is not successful within a predetermined period of time after starting the communication.

13. The information processing apparatus according to claim 12, wherein the last least one processor is further configured to perform control to display the screen in a case where communication is performed for sending a job to the electronic apparatus and receipt of a response from the electronic apparatus is not received within a period satisfying a predetermined condition.

14. The information processing apparatus according to claim 12, wherein the at least one processor is further configured to perform control to display the screen on a display unit.

15. The information processing apparatus according to claim 12, wherein the at least one processor is further configured to perform control not to display the screen in a case where communication with the electronic apparatus succeeds within the predetermined period of time after starting the communication.

16. The information processing apparatus according to claim 12, wherein the screen includes a display item that accepts an instruction to enable the specific function, and the processor is further configured to perform control to send information to the electronic apparatus as a request to enable the specific function in a case where the screen accepts an operation on the display item.

17. A method of an electronic apparatus that communicates with an electronic apparatus, the method comprising:
receiving a job from the information processing apparatus;
enabling or disabling a specific function causing the electronic apparatus to transition to a first state from a second state in response to receiving the job in the second state, the second state having lower power consumption than the first state,
performing, in a case where a power-on operation is performed on the electronic apparatus in a state where the specific function is disabled, control to display a screen prompting enabling of the specific function based on receiving a job satisfying a predetermined condition, and
executing an operation based on the received job.

18. A non-transitory computer-readable storage medium storing a program for causing an electronic apparatus that communicates with an information processing apparatus to execute a method, the method comprising:
receiving a job from the information processing apparatus;
enabling or disabling a specific function causing the electronic apparatus to transition to a first state from a second state in response to receiving the job in the second state, the second state having lower power consumption than the first state,
performing, in a case where a power-on operation is performed on the electronic apparatus in a state where the specific function is disabled, control to display a screen prompting enabling of the specific function based on receiving a job satisfying a predetermined condition, and
executing an operation based on the received job.

19. A method of an information processing apparatus that communicates with an electronic apparatus having a specific function for causing the electronic apparatus to transition to a first state from a second state in response to receiving a job in the second state, the second state involving high power consumption than the first state, the method comprising:
performing communication with the electronic apparatus; and
performing control to display a screen prompting enabling of the specific function in a case where communication with the electronic apparatus is not successful within a predetermined period of time after starting the communication.

20. A non-transitory computer-readable storage medium storing a program for causing an information processing apparatus to execute a method to communicate with an electronic apparatus having a specific function for causing the electronic apparatus to transition to a first state from a second state in response to receiving a job in the second state, the second state involving high power consumption than the first state, the method comprising:
performing communication with the electronic apparatus; and
performing control to display a screen that prompting enabling of the specific function in a case where the communication with the electronic apparatus is not successful within a predetermined period of time after starting the communication.
